(19) United States
(12) Patent Application Publication
(10) Pub. No.: US 2026/0116027 A1
(43) Pub. Date: Apr. 30, 2026

(54) SYSTEM FOR PERFORMING AN RTM (RESIN TRANSFER MOLDING) PROCESS WITH MULTIPLE INJECTION TECHNOLOGY AND RESIN TRANSFER MOLDING PROCESS

(71) Applicant: 1C COMPOSITES ENGINEERING GMBH, NIEDERBREITBACH (DE)

(72) Inventor: DIRK KRAEMER, NIEDERBREITBACH (DE)

(73) Assignee: 1C COMPOSITES ENGINEERING GMBH, NIEDERBREITBACH (DE)

(21) Appl. No.: 19/373,779

(22) Filed: Oct. 30, 2025

(30) Foreign Application Priority Data
Oct. 30, 2024 (DE) 10 2024 131 622.5

(51) Int. Cl. B29C 70/54; B29C 37/00; B29C 70/48

(52) U.S. Cl. CPC B29C 70/54; B29C 37/00; B29C 70/48; B29C 2037/903

(57) ABSTRACT

The invention relates to a system for carrying out an RTM (resin transfer molding) process with multiple injection technology and a related process, having a molding tool (W) that has an upper mold half (2) and a lower mold half (3) with a mold cavity (13) formed between them for inserting a preform (10), characterized in that the system comprises a main control unit (1) and a plurality of injection units (4.1, 4.2 . . . 4.n) for feeding resin mixture into the mold cavity (13) and a plurality of injection points (P1, P2 . . . Pn) lead from the injection units (4.1, 4.2 . . . 4.n) into the molding tool (W) and its mold cavity (13), wherein sensors for monitoring process parameters are integrated into the molding tool (W) and/or the injection units (4.1, 4.2 . . . 4.n) for monitoring process parameters, and the sensors communicate with the main control unit (1). According to the method, a multi-injection RTM process is carried out in the molding tool (W) with the multiple injection units (4.1, 4.2 . . . 4.n) via multiple injection points (P1, P2 . . . Pn) into the molding tool (W), which is controlled by the main control unit (1), wherein a coordination between the main control unit (1), the individual injection units (4.1, 4.2 . . . 4.n) and the sensors in and on the molding tool (W) and/or the injection units (4.1, 4.2 . . . 4.n) takes place throughout the entire multi-injection RTM process, including a curing process.

### CROSS REFERENCE TO PRIOR APPLICATIONS

Priority is claimed to German Patent Application No. DE 10 2024 131 622.5, filed Oct. 30, 2024. The entire disclosure of said application is incorporated by reference herein.

### FIELD

The invention relates to a system for performing an RTM (resin transfer molding) process and a resin transfer molding process according to the preamble of the first and seventeenth claim.

### BACKGROUND

The RTM process (resin transfer molding process) is a manufacturing process for producing fiber composite components with excellent strength properties and low weight. It enables the production of complex geometries with high precision and very good reproducibility.

In the RTM process, dry reinforcing materials such as glass or carbon fibers are placed in a mold cavity. The mold is then closed, creating a sealed environment. Resin is then injected into the cavity under pressure, saturating the reinforcing materials with resin and filling the mold. The resin may contain additives such as catalysts or hardeners to initiate curing or cross-linking reactions. The mold is usually evacuated and heated to improve the flow behavior of the resin (viscosity reduction) and to initiate or accelerate the curing process. Once the resin has completely impregnated the reinforcing materials and cured, the mold is opened and the finished component is removed.

It is well known that the RTM process is operated at low pressure (up to about 3 bar) and low temperature (up to about 70° C.), which makes it particularly suitable for the manufacture of composite parts.

The high-pressure RTM process, which is also well known, uses higher pressure (up to about 40 bar), which allows for faster resin flow. However, there is a risk that the reinforcement fibers will shift impermissibly due to the increased injection pressure and that the fiber orientation in the component will not match the planned specification. This mechanism makes it difficult to manufacture large-format components with high fiber volume fractions using the RTM process. Typically, the resin and mold temperatures are increased to shorten processing times. This results in lower viscosity and thus a higher flow rate of the resin. Heating also reduces the time required for the curing process. If the resin temperature is increased over a longer period of time during the manufacture of large components with long resin flow paths, the curing reaction may be initiated too quickly. Due to the gelation of the resin at the start of the curing reaction, the resin flow is impeded and may come to a complete standstill before the entire mold is filled. The reinforcing fibers are insufficiently impregnated and the component does not achieve the required properties.

The resin is typically fed using an injection device, which injects the resin (in the correct mixing ratio with the hardener required for 2K systems) into the molding tool via a mixing head. Most of the RTM systems currently in use employ an injection device with a single injection port (single-point injection system). When manufacturing large components, this limits design flexibility and increases the risk of uneven resin distribution, dry spots, and longer cycle times. Especially in the aerospace industry, where the requirements for lightweight, high-strength components are particularly high, conventional RTM processes encounter problems in ensuring uniform production of composite parts. The RTM process has been used for several years to manufacture integral components. It is a resin infusion process and is mostly used to manufacture fiber composite components. According to Wikipedia, resin transfer molding (RTM) is a process for manufacturing molded parts from thermosets and elastomers. In contrast to pressing, the molding compound is injected into the mold cavity by means of a plunger from a usually heated prechamber or distribution channel, where it cures under heat and pressure.

Formaldehyde resins (PF, MF, etc.) and reaction resins (UP, EP) with small filler particles and elastomers can be used as molding compounds. At the beginning of a cycle, a pre-plasticized and metered molding compound is located in a prechamber. First, the tool is closed. Then the molding compound is injected into the tool and left there for a certain amount of time. During this so-called dwell time, the molding compound reacts or vulcanizes. This depends on various factors (resin type, filler, processing pressure, and temperature). Once the dwell time is over, the tool can be opened. The molding compound previously filled in is now solid (cured) and is now referred to as a molded part. This can now be removed from the mold. The mold is then cleaned and a new cycle can begin. The molding compound required for pressing and post-pressing should always be larger than the final molded part so that the tool is completely filled. This ensures that the molded part is completely formed and no air is pressed in. The excess molding compound remaining in the prechamber, also known as residual cake, must be removed before the start of the new cycle and replaced with new molding compound.

In order to process long fibers or semi-finished fiber products (prewovens/preforms/preforming), these are first inserted into the mold and overmolded with the molding compound. To avoid air pockets, the cavity (mold cavity) is usually evacuated as well. Resins with low viscosity are usually used as injection resins. This keeps the flow resistance low when flowing through the mold and requires smaller pressure differences for filling. Reaction resins for RTM processes are offered as special injection resins consisting of a resin and hardener component. During the injection process in the RTM process, resin flows through the mold cavity at the appropriate flow rate, fills it, wets the inserted materials, and exits the mold.

In patent literature, for example, publication DE 600 11 752 T2 A describes a process for manufacturing structural parts from composite material using the resin injection process and a corresponding device. With this solution, the vacuum seal of the closed mold is verified before the resin transfer, and cured resin residues that are not used for the component are removed from a container that is used for additional conditioning and additional supply of resin. Furthermore, the pressure is measured to determine the tightness of the mold, and a temperature control device is provided.

Furthermore, publication DE 10 2007 060 739 A1 discloses a method and a molding tool for manufacturing fiber composite components, in which the course of the flow front is detected by pressure sensors facing the mold cavity and the cooling in the edge area is varied depending on the flow front. DE 10 2009 010 692 A1 describes, among other things, a device and a method for carrying out an RTM process, wherein the device comprises an injection system and a closable tool provided with a mold cavity, and the injection system is coupled to the tool such that an injection resin can be introduced into the tool, wherein the tool has at least one resin outlet that can be closed by means of a closing device and is connected to the mold cavity, from which injection resin can escape after the mold has been filled. The fiber composite component can be monitored during the manufacturing process using process sensors, wherein the process sensors are coupled to the process control device for control purposes. A camera is provided in a transparent area of the tool, which captures an image of the fiber composite component being produced. The pressure and temperature in the tool are also recorded using appropriate sensors. Furthermore, a mixing head is provided in which the components are mixed immediately before injection. With this solution, there is no way of detecting resin leakage from the mold when it is filled.

The publication DE 199 22 850 C1 describes a device for manufacturing components from fiber composite materials, wherein a mold is provided with connection means for injecting a resin and for pressure relief, consisting of cooperating mold parts, wherein at least one mold part is designed in a dimensionally stable manner in accordance with the contour of the outer surface of the component, and a fiber fabric set is insertable between the cooperating mold parts. The lower part of the mold is the resin inlet device, for which corresponding channels are provided. A connection means in the form of a flow valve is provided on the inlet and outlet sides of each channel, which is connected to a control system by means of control lines. This allows a single line to be opened or closed, but it is also not possible to detect the resin outlet from the mold accordingly.

The publication EP 2 588 297 B1 describes a device for carrying out a resin transfer molding (RTM) process in which the resin outlet can be detected. For this purpose, a pressure sensor is integrated and the plastic hose or line at the resin outlet is at least partially transparent, and the resin outlet can be detected by means of a capacitive sensor. When a specified pressure is exceeded, the closed resin flow closure unit reopens.

It is also known to track the flow fronts of the resin mixture.

In the patent DE 10 2017 122 585 A1, two injection units are used, which lead to a mixing area, and the material mixed therein is fed from there into the mold via a single feed and thus via only one injection point.

The solution according to DE 10 2011 051 391 A1 also uses only one injection unit from which only one injection point leads into the tool.

A solution for multi-point injection is known, for example, from publication KR 10 2017 001 857 A. In this solution, sensor units comprising a temperature sensor, a pressure sensor, and an eddy current sensor are arranged in the tool. Pressure and temperature are measured to check whether the filling quantity of the polyurethane resin has been reached. In addition, the eddy current sensor can be used to measure the opening time of the mold by measuring whether the liquid resin has cured and transitioned to a solid phase after the polyurethane (PU) material has been filled.

A multi-injection RTM process is also known from publication JP 2011-169010 A. In this process, the arrangement density of the resin inlets is increased in areas with a higher density of the inserted part. This results in a larger amount of resin being injected, which should lead to a more uniform quality, but this cannot be reliably achieved.

Another publication on an RTM process with multiple injection is WO 2002/096 618 A1. Here, several pressure sensors are provided for pressure monitoring. A main control unit communicates with the pressure sensors. However, only ONE injection unit is provided, from which several injection points are “served.” Therefore, it is not possible to direct the resin flow from the two injection points at D1 specifically to a venting point or resin outlet. The injection openings are arranged one after the other from the circumference of the mold inwards towards the central outlet opening. The resin is first injected into the outermost injection points. When a valve detects a positive increase in the internal tool pressure, the control pressure is applied to a divert valve to close the initial peripheral injection point and open one or more subsequent inner injection points to promote resin flow toward the center while maintaining a negative internal mold pressure. Thus, the resin flow is directed toward the center of the mold by opening one or more injection points.

All of the above solutions have the disadvantage that very large integral components, such as those required for aircraft, wind turbines, and the like, cannot be produced in high quality using multiple injection.

### SUMMARY

An aspect of the invention is to create a system for carrying out an RTM (resin transfer molding process) and a resin transfer molding process with multiple injection technology, which ensures reliable penetration of the semi-finished product inserted into a mold with the injected resin mixture/resin-hardener mixture and a high quality of the parts produced with multiple injection, i.e., injection of the resin mixture at several injection points of the tool.

This object is solved with the features of the first and sixteenth patent claim. Advantageous designs result from the subclaims.

### BRIEF DESCRIPTION OF THE DRAWINGS

The present invention is described in greater detail below on the basis of embodiments and of the drawings in which:

FIG. 1 shows a schematic representation of the system (or plant) with a molding tool with an inserted semi-finished fiber product of uniform thickness;

FIG. 2 shows a schematic representation of a molding tool with an inserted fiber semi-finished product of varying thickness;

FIG. 3 shows a representation of the components for implementing the multi-injection RTM process;

FIG. 4 shows a schematic representation of the main control unit and one of the injection units for the multi-injection RTM system; and

FIG. 5 shows a highly simplified representation of flow fronts at six injection points P1 to P6.

### DETAILED DESCRIPTION

The system (or plant) according to the invention for carrying out a resin transfer molding (RTM) process with a molding tool, which has an upper mold half and a lower mold half with a mold cavity formed between them for inserting a preform, is equipped with a main control unit and has a plurality of injection units for feeding resin mixture into the mold cavity, wherein a plurality of injection points lead from the injection units into the mold and into its mold cavity, and sensors for monitoring process parameters are integrated into the mold and/or the injection units, and the sensors communicate with the main control unit.

The injection units are controlled via the main control unit and their pressure and/or volume of the injected resin mixture is changed depending on parameters in the molding tool.

Sensors for detecting the flow behavior of the injected resin mixture are integrated into the molding tool. These are flow detection sensors in the form of pressure, optical, and/or ultrasonic sensors. According to the prior art, ultrasonic sensors for detecting flow fronts have already proven themselves.

Furthermore, at least one capacitive sensor is arranged on a vent hose at at least one resin outlet of the molding tool.

The capacitive sensor is used to detect resin leakage at the resin outlet and to detect air bubbles in the outgoing resin mixture.

The main control unit is coupled to the injection units as the “brain” of the plant (master) or system for the transmission of commands.

The sensors integrated into the mold transfer the recorded data to the main control unit in real time.

The main control unit can display critical data based on the data transmitted continuously in real time and, in particular, the status of an RTM process.

The main control unit can be used to analyze the data from the molding tool in order to evaluate the performance of each individual injection unit and the resin distribution within the mold. The main control unit can be used to compare the actual process parameters with predefined targets or setpoints, in particular to determine whether adjustments are necessary.

If adjustments are necessary, the main control unit transmits the changed parameters to each individual injection unit so that these settings can be implemented independently of each other in each injection unit.

For example, the pressure, volume, resin/hardener mixing ratio, temperature of the resin mixture, and, of course, a combination of the aforementioned parameters can be changed as parameters to be modified by corresponding commands from the main control unit.

Furthermore, as already described above, the position of flow fronts can be determined from the data transmitted to the main control unit by the sensors.

By detecting resin flow fronts via the main control unit, it is possible to determine at which points the resin flow fronts will meet.

A significant advantage of the system (or the plant) is that, for the first time, it is possible to use the main control unit to direct an area where the resin flow fronts meet to a resin outlet and/or a vent opening of the molding tool.

This is possible, for example, because the speed of the flow fronts can be changed by altering the injection pressure and/or the flow rates of the individual injection units in order to direct several flow fronts to a resin outlet and/or a vent opening of the molding tool.

On the outlet side, at least one sensor for detecting air bubbles in the resin mixture is provided at the resin outlet or in an area (hose) downstream of the resin outlet. A capacitive sensor and/or an optical sensor is preferably used as the sensor for detecting air bubbles.

The area in which the sensor or sensors for detecting air bubbles are arranged is designed as a transparent area in an area through which the resin mixture flows, wherein the capacitive sensor and/or the optical sensor are arranged on the outside of the transparent area.

The sensor(s) for detecting air bubbles are connected to the main control unit and transmit information to it about the amount of air bubbles present in the resin mixture, whereupon the main control unit transmits a signal to the resin closing unit(s) to automatically close the resin outlets when there are no or almost no air bubbles in the outgoing resin, or to open or keep open when there are still air bubbles in the resin mixture.

Furthermore, the main control unit is coupled to the heating device of the molding tool and/or the heating devices of the storage container and/or lines through which the resin-hardener mixture flows, for monitoring and regulating a start-up curve and for achieving a specified target temperature. The main control unit stores the energy input and the resulting outcome and independently controls the higher circulation temperature of the heating medium required to reach the operating temperature. This also takes into account the power loss through the supply lines and the waste heat from the tool. Excessive energy input is prevented by a percentage limitation of the desired temperature.

At least one vent hose is arranged on the outlet side of the molding tool, for example in or after one or more resin outlets, through which the air present in the resin mixture can escape. At least one capacitive and/or optical sensor can be used to monitor the filling level of the vent hose and/or to determine the amount and/or size of air bubbles in the resin mixture. These characteristic values are then visualized for the operator in the system control.

The sensor(s) for detecting the filling level of the vent hose and/or the amount of air bubbles and/or the size of air bubbles are connected to the main control unit, and the current amount of air bubbles and/or size of air bubbles at the at least one resin outlet can be determined. This characteristic value is used by the control logic to automatically open and close the resin outlets (resin flow closing unit) for the purpose of automated venting of the component to be injected. By comparing with a predefined maximum value for the filling state of the vent hoses, the component is automatically injected or vented until the maximum air bubble limit value is reached.

The process according to the invention includes a continuous real-time communication system for the multi-injection RTM process.

The multi-injection RTM system thus ensures efficient coordination between the main control unit, the individual injection units, and the sensors in and on the molding tool during the entire multi-injection RTM process, including the injection and curing process:
The main control unit serves as the “brain” of the system (master) and seamlessly transmits commands to the individual injection units, which act as the executors of the commands (slaves).
All sensors embedded in the molding tool continuously transmit critical data to the main control unit in real time, providing insight into the status and dynamics of the RTM process.
The main control unit analyzes the data transmitted from the molding tool via the sensors to evaluate the performance and parameters of each individual injection unit and the resin distribution within the molding tool/in the mold cavity with that of the inserted preform, and compares the actual process parameters with predefined targets or setpoints stored in the main control unit to determine whether adjustments are necessary.
Based on the analysis of the sensor data, the main control unit communicates the changed parameters to each individual injection unit so that each injection unit can receive and implement these settings independently of each other.

Another aspect of the multi-injection RTM process and the system or plant for carrying it out, according to the invention, is the detection and guidance of resin flow fronts in the closed tool.
The position of the flow fronts can be detected by means of the real-time communication described above between the sensors used in the mold and the main control unit. The flow fronts are detected by combining the data transmitted to the main control unit from the tool sensors (flow detection sensors (pressure, optical, and/or ultrasonic sensors) and the capacitive and/or optical sensor on the vent hose.
By detecting resin flow fronts, the main control unit can determine/calculate at which points the resin flow fronts of the resin mixture injected into the tool via the individual injection points will meet.
If it is determined that flow fronts will not meet in the area of a resin outlet, the flow fronts are directed toward or to the resin outlet.
This directs the area where the flow fronts meet to a venting point, preferably a resin outlet.

This results in the first-ever automatic control of the injection process, including control of the resin flow fronts in the closed tool, by the main control unit. The following process steps are carried out:
The sensors and their communication with the main control unit, and in turn the communication of the main control unit with all injection units, are implemented in order to achieve uniform resin distribution throughout the entire preform during sequential injection or variable pressure injection, which cannot be observed in the closed mold.
The system analyzes the data from the tool sensors in real time and calculates the required injection quantity of the individual injection units at the assigned injection points in order to control the flow fronts. The speeds of the flow fronts are adjusted by changing the injection pressure and/or the flow rates of the individual injection units in order to guide the flow fronts to the respective venting points (resin outlets).
The ability to use and control multiple injection points with multiple injection units for very large components allows the flow paths to be shortened, thereby significantly reducing the internal tool pressure in the area of the injection point.
The injection time is shortened. However, in order to prevent areas with inclusions or insufficient resin content from being created by flushing in the event of a collision between several flow fronts, the flow fronts are actively readjusted.

Another essential aspect of the process and system according to the invention is the detection of air bubbles at the resin outlets:
The multi-injection RTM system can detect air bubbles in the resin system that escape from the resin outlets by using capacitive sensors and/or optical sensors. In addition, these sensors can be used to measure the amount of air bubbles present in the resin system.
The detection of air bubbles and the measurement of the amount of air bubbles serve to ensure that the injection or flushing process is only completed when the component is completely filled and the limit values for the air volume in the resin-hardener mixture have not been exceeded before the injection is completed.

A further advantage of the solution according to the invention is the automatic venting of air bubbles at the resin outlet or outlets. This is described below:
Based on the detection of air bubbles by means of capacitive sensors and/or optical sensors at the resin outlet(s), information about the amount of air bubbles present in the resin mixture is forwarded to the main control unit.
Based on this information, the multi-injection RTM system can change the process parameters of individual injection units or several injection units simultaneously to ensure that there are no air bubbles in the mold.
After changing the process parameters of the injection units, the multi-injection RTM system can analyze the changes based on data from capacitive sensors and/or optical sensors and send a signal to the resin closing unit to automatically close and open the resin outlets.

In accordance with the process, the tool pressure is automatically reduced by a control logic, which is described below:
The internal pressure in the mold and the pressure at the injection points are continuously monitored by the multi-injection RTM system using pressure sensors located in the tool and on the mixing head. The multi-injection RTM system can independently detect areas with excessive pressure (above the defined limit value) and open a resin outlet in this area by communicating with the resin closing unit or the control parameters of the injection units until the pressure is back within the limit range.
In this variant, one or more resin outlets are opened to reduce the internal pressure in the molding tool to a specified maximum value or below.
This is similar to the description of variable pressure control. With variable pressure control, the pressure is controlled via the pump capacity of the pumps for resin injection. The internal pressure can also be reduced by reducing the pump pressure.
Alternatively, if the internal tool pressure is too high, both the resin outlets can be opened and the pump pressure reduced in order to bring the internal tool pressure below a specified maximum pressure.

When the limit values specified in the main control unit are reached, the delivery volume is first adjusted and then continuously reduced. The respective resin outlets located in the area of the pressure evaluation unit of the molding tool W can be opened alternatively or additionally if reducing the mold internal pressure by reducing the delivery volume was not sufficient. This results in an automatic reduction of the mold internal pressure by the control logic of the main control unit.

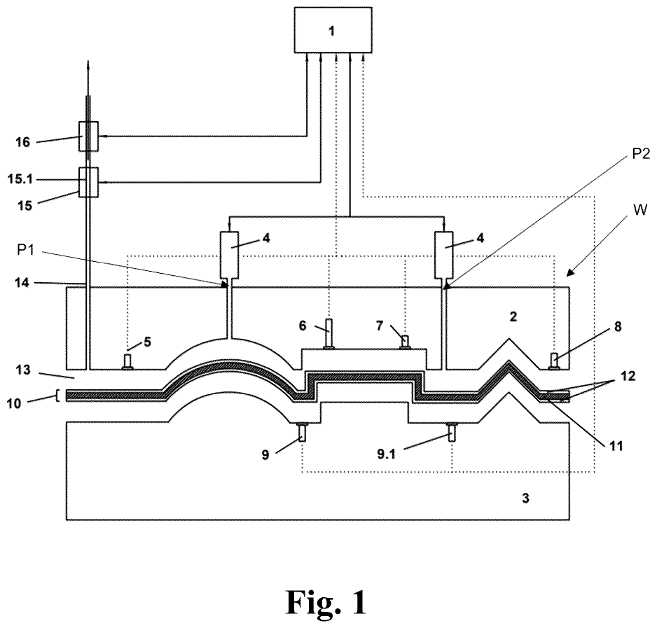

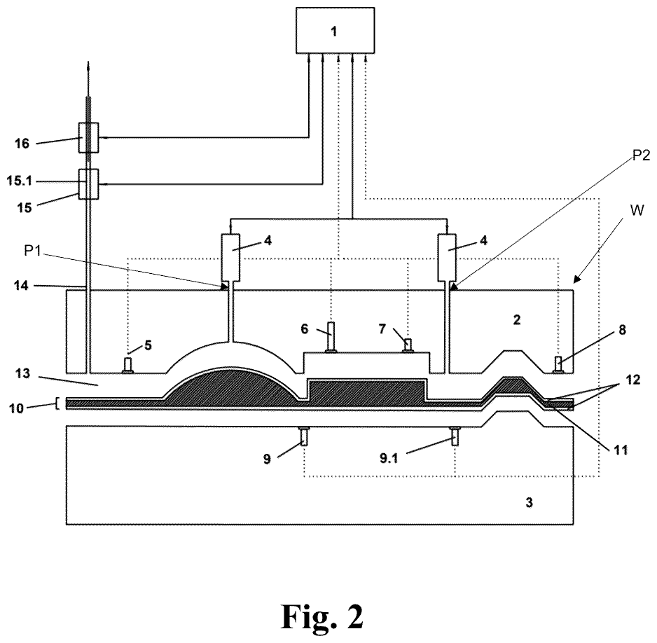

FIGS. 1 and 2 show a representation of a closable molding tool W, which is used to manufacture composite parts from a semi-finished product with uniform thickness (FIG. 1) or varying foam core thickness (FIG. 2). Both figures also include the sensors used for real-time monitoring during the multi-injection RTM process, including sensors for pressure, temperature, flow detection, and curing. The number of sensors, resin outlets, and resin closing units can be adjusted depending on process requirements and mold size. This flexibility ensures optimal performance and precise control during the manufacturing process.

The system has a main control unit 1, as shown in FIGS. 1 and 2.

The molding tool W consists of an upper mold half 2 and a lower mold half 3, which are open here.

At least two injection units 4.4, 4.2, which are spaced apart from each other, lead to the mold cavity 13 between the two mold halves, resulting in two injection points P1 and P2, which lead to the mold cavity 13 via unlabeled channels. It is understood that more than two injection units and thus more than two injection points can also be provided.

Furthermore, it is possible for more than one injection point to lead from one or more injection units to the molding tool.

At least one temperature sensor 5 is integrated into the tool, in this case into the upper mold half 2. Furthermore, at least one pressure sensor 6, at least one inclination sensor 7, and at least one distance sensor 8 are integrated here in the upper mold half 2. The lower mold half 3 preferably has at least one flow sensor 9 and at least one sensor for monitoring curing 9.1.

All sensors shown in the molding tool W as examples can be integrated into the upper and/or lower mold halves 2, 3.

A semi-finished product made of fiber material, a preform 10, has been inserted between the two mold halves 2, 3, which has, for example, a core material 11 and outer fabric layers 12, wherein the preform 10 is now located in the mold cavity 13 between the mold halves 2, 3.

A resin outlet 14 is also provided here in the upper mold half 2 (wherein several resin outlets may also be present), which leads via a preferably transparent area 15.1 with a capacitive sensor 15 to a resin closing unit 16.

The injection units 4, the sensors in the form of the temperature sensor(s) 5, pressure sensor(s) 6, inclination sensor(s) 7, distance sensor(s) 8, flow sensor(s) 9, capacitive sensor(s) and the resin closing unit 16 are connected to the main control unit 1.

The mold cavities 13 shown in FIGS. 1 and 2 are designed according to the component shape to be produced.

In FIG. 1, the semi-finished product in the form of the preform 10 has a uniform thickness. In FIG. 2, some unlabeled areas of the preform 10 are thicker and others are flatter.

Advantageously, the main control unit 1 and the injection units 4 consist separately for the first time of two different components: the RTM control unit in the form of the main control unit 1 (control unit) and the RTM injection units in the form of the injection units 4.1, 4.2 to 4.n.

To manufacture a component using the system and method according to the invention, a preform 10 is inserted into the mold cavity of the molding tool W and the tool is closed. The sensors of the molding tool W are connected to the main control unit via cables and the injection units 4.1, 4.2 . . . 4.n are also coupled to the main control unit 1.

Furthermore, the injection units 4.1, 4.2 . . . 4.n are connected to the corresponding injection points P1, P2 . . . Pn on the molding tool W.

The resin outlets are connected to the molding tool and the resin closing units are connected to the main control unit.

For the injection process, the resin outlets are connected to a vacuum system and the injection of the resin plus hardener mixture into the mold is started by individual injection units, all of which are controlled and operated by the main control unit 1. This impregnates the preform with the resin-hardener mixture.

Based on the sensor feedback at the resin outlets, the resin closing units close the outlets as soon as the mold/mold cavity is filled and the resin-hardener mixture escapes from one or more resin outlets.

The curing reaction is initiated by an increase in the temperature of the molding tool. The temperature is maintained until the curing process is complete.

After completion of the RTM process and curing, all connections of the molding tool W sensors are disconnected from the main control unit 1.

The injection units 4.1, 4.2 . . . 4.n are then disconnected from the injection points P1, P2 . . . Pn.

The molding tool W is opened and the finished part can be removed.

The overall modular design with a flexible number of injection units 4.1, 4.2 . . . 4.n and injection points P1, P2 . . . Pn enables greater flexibility and adaptability in the manufacture of large-format components using the RTM process, for the first time, according to the invention, with multiple injection points.

The number of injection units 4 required and thus the number of injection points can be selected by the component manufacturer according to production requirements.

In contrast to injection systems with a single injection point, the system according to the invention operates with a plurality of injection units 4.1, 4.2, etc. and a plurality of injection points P1, P2, etc., wherein each injection point P1, P1, etc. is preferably controlled by its own RTM injection device in the form of injection unit 4.1, 4.2, etc.

The various injection units 4.1, 4.2, etc. are controlled via the main control unit 1, which processes the information from all injection units 4.1, 4.2, etc. connected to the molding tool. This means that the parameters at each injection point P.1, P2, etc. can be controlled separately, but the information from other injection units and the molding tool W is taken into account in the control.

Advantageously, the parameters at each injection point P.1, P2, etc. can therefore be controlled separately, depending on the real-time feedback of the resin flow (measured with the flow detection sensors 9) and/or the injection pressure (measured with the pressure sensors 6) from other injection units 4.1, 4.2, . . . 4.n and the real-time sensor response of the other sensors integrated into the mold (see description above). By creating multiple injection points P2, P2 . . . Pn, a fast mold filling process can be achieved, resulting in short cycle times and better part quality.

In addition, this allows large flow paths to be realized, enabling large-format components to be manufactured using the RTM process.

By integrating additional sensor technology, the system achieves an unprecedented level of automation and ensures ideal conditions through continuous monitoring of resin flow, temperature, and pressure throughout the entire process.

The networked design enables coordinated and synchronized operation of injection units 4.1, 4.2 . . . 4.n during the RTM process.

The main control unit 1 is a control unit and acts as the brain, so to speak, issuing commands to the injection units 4.1, 4.2 . . . 4.n and coordinating the injection process.

This invention thus significantly improves the precision of resin distribution and overall control during the manufacturing process.

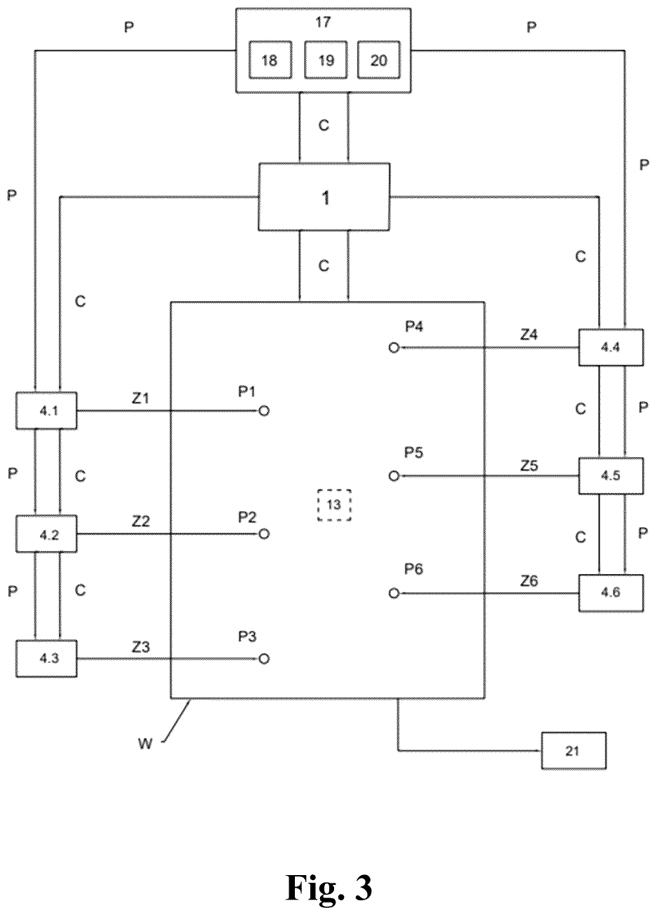

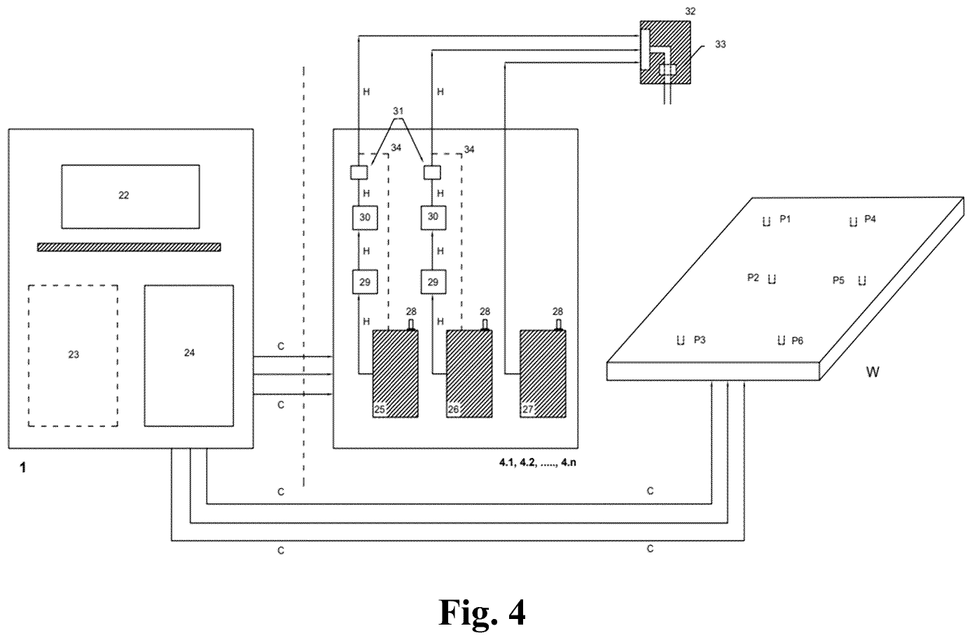

FIG. 3 shows a representation of the components for implementing the multi-injection RTM process, and FIG. 4 shows a schematic representation of the main control unit 1 and one of the injection units 4 for the multi-injection RTM system.

The main control unit 1 (control unit) gives the operator access to all components connected to the system.

The main components of the control unit 1 include a user interface with a graphical user interface, all electrical circuits, sensor indicators, and control switches.

The sensor indicators are used to display the status and/or performance of the sensors.

Secondary components in the form of identification tags and intelligent LED lights are also used to display the process stages of the RTM process. These components of control unit 1 are not shown.

The injection devices in the form of the six injection units 4.1 to 4.6 indicated here consist of resin containers 25, hardener containers 26, and cleaning fluid containers 27, metering pumps 30, mixing head 32, hoses, and an automatic cleaning unit for cleaning the hoses and the mixing head 32.

Furthermore, the six injection units 4.1 to 4.6 shown here include the necessary hoses H, resin and hardener pumps 29, an integrated heating system for heating the pipes and the tank, vacuum pumps, air bubble detection sensors, temperature sensors, pressure sensors, and flow sensors, which are also not shown.

An automatic refill station 17 is also provided, which is connected to the injection units 4.1 to 4.6. The automatic refill station 17 has storage containers with resin 18, hardener 19, and/or cleaning fluid 20 (e.g., acetone). At least one additional storage container 21 may be provided, for example, for resin that leaks from the mold.

Indicated lines P lead from the refill station 17 to the injection units 4.1 to 4.6, which in turn communicate with the main control unit 1 by means of cables C.

The injection units 4.1 to 4.6 are connected via lines Z1 to Z6 to injection points P1 to P6 on the molding tool 1, which lead to the mold cavity 13.

The secondary components include pumps, valves, and level sensors, as well as control systems for implementing the refill processes to the injection units, which are not shown.

The molding tool W shown in FIGS. 1 and 2 has a mechanical, hydraulic, pneumatic, or magnetic clamping system, depending on the clamping force required to close the mold. The clamping system is used to close the upper mold half 2 and the lower mold half 3 with the necessary closing force to withstand the pressure when injecting the resin/hardener mixture.

Furthermore, temperature sensors 5, pressure sensors 6, inclination sensors 7, distance sensors 7, and flow sensors 9 are integrated into the molding tool (see FIGS. 1 and 2). The main control unit continuously monitors the injection process (using flow sensor(s), temperature sensor(s), pressure sensor(s)) and the curing process (e.g., tool-mounted electrical sensors, ultrasonic sensors, optical sensors, or viscosity sensors). The main control unit 1 regulates the process parameters of all injection units 4.1, 4.2 . . . 4.n.

Advantageously, the molding tool W also has one or more identification tags (not shown), an ejector system for removing the finished component, and a curing monitoring system. Ultrasonic sensors, for example, are used to monitor the curing process.

The new process and device were developed specifically for the requirements of manufacturing large-format fiber composite components. The integration of multiple injection points P1 . . . Pn is its characteristic feature, offering several advantages over single-point injection systems. These advantages are reflected in better resin distribution, faster production cycles, and greater accuracy throughout the injection process, leading to a significant change in composite manufacturing technology.

The system consists of a total of four different components: the main control unit 1, the injection units 4.1 to 4.n, each of which is connected to at least one injection point P1 to Pn, the automatic refill station 17, and the molding tool W.

The control unit 1 consists of a central processing unit, interface panels, process control software, and communication modules. This also includes microprocessors or microcontrollers for processing commands and data; interface modules for communication with sensors and the injection units; memory units for storing commands, process parameters, and data logs; control algorithms for coordinating the movements of the injection units and managing the injection process.

The system has a robust communication network, such as Ethernet or CAN bus, to facilitate data exchange between the injection units and the control unit. Data exchange via the communication network can be wired or wireless.

The main control unit 1 is programmed to recognize and communicate with each injection unit 4.1 to 4.n in the system, wherein the roles and responsibilities of each injection unit 4.1 to 4.n are defined based on the specific requirements of the RTM process with multiple injection technology.

The main control unit 1 can define sequences for resin injection, taking into account factors such as tool geometry and resin flow dynamics.

Synchronization signals or time-based triggers are used to coordinate the movements and actions of the individual injection units 4.1 to 4.n.

Each injection unit 4.1 to 4.n incorporates sensors and monitoring devices (not shown) for determining the injection pressure and flow rate in order to obtain real-time feedback on their status and performance.
Changes to the process parameters of a specific injection unit can then be made based on the measured parameters such as injection pressure and/or flow rate
or
the changes to the process parameters of a specific injection unit are made based on real-time feedback of the flow rate and/or injection pressure from other injection units 4.1, 4.2 . . . 4.n and the real-time sensor response from the tool.

The solution according to the invention thus provides a multiple injection system with sequential injection and/or variable pressure injection.

An injection unit 4.1 to 4.n can be operated at one or two, or possibly even more, injection points, depending on customer requirements and/or process requirements and/or the complex shapes and geometries of the parts.

Each injection unit has a separate mixing head for mixing resin and hardener.

The mixing head can be equipped with temperature sensors and/or pressure sensors (see FIG. 4) to measure the temperature and pressure of the resin system at the time of the injection process. Sensors for detecting the mixing ratio of the mixed components can also be integrated (e.g., with density measurements or spectroscopy or by detecting the refractive index). If the mixing ratio of individual components deviates from the desired mixing ratio, the sensor sends a signal to the main control unit 1. The main control unit 1 then sends a signal to the respective injection unit(s) to make changes to the flow rates of the respective components and correct the mixing ratios. The mixing head also has a cleaning option to clean the mixing head with cleaning fluid after the injection process is complete.

If the stored values for the mixing ratio are exceeded or not reached, the control system adjusts the respective delivery rate by means of a correction calculation.

Sequential injection is a process in which the resin system is injected sequentially into the mold cavity 13.

First, the first injection unit 4.1 initiates the resin injection. As soon as the second injection unit 4.2 detects a resin flow, it is activated to continue the injection process, while the first injection unit 4.1 stops operating.

This sequential injection pattern continues until the entire mold is filled with resin in succession via injection units 4.1 to 4.n.

In contrast, in the variable pressure injection method, the resin is injected simultaneously from all injection units 4.1 to 4.n.

When detecting the resin flow, the flow detection sensors 9 send feedback to the main control unit 1. The main control unit 1 then adjusts the injection pressure of each individual injection unit 4.1 to 4.n.

This dynamic adjustment is important to prevent air bubbles from being trapped, especially when flow fronts from multiple injection points P1 to Pn converge in the mold.

By regulating the injection pressure in real time, the variable pressure injection method ensures even resin distribution and minimizes defects, which ultimately improves the quality of the composite part produced.

The main control unit 1 issues commands to the injection units 4.1 to 4.n based on process requirements and the measurement data from the sensors. Real-time feedback data from all sensors integrated in the mold is delivered to the main control unit.

This main control unit 1 controls the operation of the injection units 4.1 to 4.n and coordinates their actions for optimal performance.

The automation of the process sequence takes place automatically during the injection process.

If the operator determines that the injection routines of all multiple injectors are suitable for the production of the respective part, they can start the injection process.

If the operator wishes to make changes to the parameters for the injection routine, they can adjust the parameters according to requirements before starting the injection process.

This process of parameter adjustment ensures correct resin flow during the manufacture of composite parts. However, if during the injection process the resin flow does not function according to the simulated data (which is stored in the system) or if dry stops are observed in the mold during the process (this feedback is received from the sensor technology implemented in the mold to detect air bubbles at the resin outlet and/or to detect the resin flow in the mold), some process parameters, such as the injection pressure of all injection units, can be changed individually. Changes can be stored in the main control unit for future applications. This gives the operator partial control if they detect an error during the injection process.

Therefore, the injection process is preferably controlled fully automatically or, optionally, partially manually (if required) to ensure proper resin impregnation of the fabrics based on the feedback provided by the sensor system in the form of real-time feedback data from all sensors integrated into the mold.

This new approach will improve processing capabilities for faster response times and better control over the injection process.

A refill station 17 equipped with large storage containers—a container 18 with resin, a container 19 with hardener, and a container 20 with cleaning fluid—ensures a steady supply to the containers 25, 26, and 27 of the individual injection units 4.1, 4.2, . . . 4.n. The storage containers 18, 19, 20 can be equipped with an integrated heating system if preheating of resin and hardener components is required. The refill station 17 is connected to the injection units 4.1, 4.2, . . . 4.n via hoses or heatable hoses and performs a refill operation when the level sensor(s) in the smaller containers of the injection units 4.1, 4.2, . . . 4.n signal to the main control unit 1 that the level has fallen below the required level. This refill process can be controlled and operated via the main control unit 1 or independently of each other.

Water is preferably used as the heating/cooling medium for heating/cooling the two pressure vessels 18, 19 and the hoses not shown.

All containers 18, 19 of the refill station and also the containers of the injection units 4.1, 4.2, . . . 4.n, which are not shown, are equipped with an agitator. The fill level of the containers is preferably measured by capacitive sensors, which ensures that the required amount of material is present in the storage container before the injection process is continued. The material is constantly degassed via a thin-film degassing system (not shown).

These pre-feed pumps also ensure a constant supply of material to the servo motor-driven metering pumps, which are designed as gear pumps. The installed gear pumps can be selected by the customer based on their drive power and mixing ratio range.

The mixing ratio of resin and hardener can be specified in advance for the component or determined and adjusted during the injection process and also visualized in the main control unit 1. If the stored values for the mixing ratio are exceeded or not reached, the main control unit can readjust the mixing ratio and/or the respective delivery rate via a correction factor.

The system according to the invention has air bubble detection sensors that measure the presence of air bubbles in the hoses before they are fed to the tool W. The temperatures and pressures are continuously monitored both in the containers 17, 18, and, optionally, in the containers of the injection units 4.1, 4.2 . . . 4n not shown, as well as in the unlabeled recirculation and metering lines. The components of the injection material are mixed in the static mixing head of the injection units and fed to the molding tool W via a heatable hose. The flow rate of each component is monitored by flow sensors and the current mixing ratio is calculated by the main control unit 1. This ensures a constant flow rate and the material-specific mixing ratio.

Each injection unit 4.1 to 4.n can be operated with up to three component versions of a mixing head 32, depending on production requirements and processing parameters. Each injection unit is assigned a mixing head 32 (see FIG. 4). The mixing head 32 is equipped with several openings or channels through which different resin components can be introduced. These components can include the base resin (one or more), hardener (one or more), and other additives. The design with regard to the mixing ratio serves only to optimize the speeds so that a wide range of delivery rates is possible. It therefore does not matter whether the system is designed for a mixing ratio of 100:1 or 100:100.

Cleaning of the mixing head with air and cleaning fluid, e.g., acetone, including the hoses, would preferably be carried out at the same time.

For precise control of the injection process, molding tools W with resin outlets 14, temperature sensors 5, and pressure sensors 6 (number depending on the tool size) can be connected to the main control unit 1. Depending on the surface area of the preform 10 and thus of the component to be manufactured, it is preferable to provide two or more resin outlets 14 at points spaced apart on the molding tool W. The monitoring of pressure, temperature, and mass flow is combined with special resin outlets 14 in the molding tool W. These consist of a capacitive measuring unit with one or more capacitive sensors 15 for resin flow detection and a pneumatically controlled pinch valve (not shown). These capacitive sensors 14 can also be used to detect the quantity or size of air bubbles in the outlet hose.

In the subsequent process automation, this characteristic value is used by the control logic to automatically open and close the resin outlets 14 by determining the ratio between the change in capacity (feedback from the sensors) and the volume of air bubbles present in the resin. This feedback is then returned to the control unit in order to change/regulate the process parameters of the individual injection units accordingly. The sensors are mounted in the mold in order to detect the resin flow in the mold during the injection process. In addition, the mold has various types of sensors (distance sensors, inclination sensors), e.g., to detect the distance between two mold halves, to ensure that the mold is properly closed before the injection process begins, and also to detect the tool angle position.

Typically, an electrical heating system which is not shown (or another system, depending on the application) is used to heat/cool the mold. This heating/cooling system can be used as a separate additional component and is controlled and operated separately or by the main control unit 1 (depending on the size of the mold).

The tool also features real-time monitoring of the curing process. For this purpose, one or more sensors are integrated to monitor the curing process. These can be dielectric sensors, ultrasonic sensors, optical sensors, or viscosity sensors.

These provide information about the viscosity and/or Tg value (glass transition temperature) and/or the degree of curing in real time to the main control unit 1.

The mold then contains ultrasonic sensors (not shown), for example, which provide information about the completion of the curing process. Based on this information, the main control unit 1 can optimize the process parameters in order to obtain high-quality composite parts for future applications.

All important parameters, such as feed rates, mixing ratio, resin discharge, flushing processes, medium temperature, tool temperature, air bubble properties, medium injection pressure, and tool internal pressure, are controlled and documented by the main control unit 1.

The necessary changes to the aforementioned parameters are made based on the feedback provided in real time by the sensors/sensor systems.

Once a process routine has been created, it can be repeated for mass production of the same component. As this is a completely closed system, oxidation or crystallization of the resin system is reduced.

For resin systems that react very strongly to the ambient air, it is possible to reduce the container overpressure with a nitrogen cylinder instead of compressed air.

The system has overload protection for the pumps (not shown), the mixing head, and the hose lines (also not shown). This automatically prevents material from being conveyed when the mixing head is closed.

FIG. 4 shows a schematic representation of the connection between the main control unit 1, an exemplary injection unit 4.1, and the molding tool W. The main control unit has at least one monitor 22 (PC) as well as electronic circuits and control panels 23 (of the control unit) and sensor displays and control panels 24. The injection unit 4.1 shown here as an example (as well as the other injection units 4.2 . . . 4.n) shown here as an example have a small storage container for resin 25 (component 1), a small storage container for hardener 26 (component 2), and a small storage container for cleaning fluid 27. Each small container 25, 26, 27 has a level sensor 28. For the injection process, resin and hardener are conveyed from the containers 25, 26 by means of pumps 29 (pre-pumps or gear pumps) and metering pumps 30 to a mixing head 23 via heatable hoses H in which flow sensors 31 are integrated. One or more sensors 33 are arranged in the mixing head 32, in particular at least one temperature sensor and/or at least one pressure sensor and/or at least one density/ultrasonic/optical sensor. A bypass system 34 leads from the hoses H back to the containers 25 and 26 upstream of the mixing head. The resin and hardener components are mixed in the mixing head 32 and conveyed via a supply line Z1 to the injection point P1 of the molding tool W shown and injected into the mold cavity containing the preform 10.

Additional mixing heads of identical injection units 4.2 to 4.6 are also connected to injection points P2 to P6 of the molding tool W and also inject the resin-hardener mixture into the molding tool W via these points.

The main control unit 1 is connected to the injection units 4.1 to 4.6 and the tool via cable C. Signals from all sensors of the tool and the sensors of the injection units 4.1 to 4.6, including the sensors of the mixing head 32, are transmitted to the main control unit, preferably in real time. The main control unit 1 controls the injection process of the injection units 4.2 to 4.6 in dependence on these signals.

A further small control station, not shown, may advantageously be attached to the molding tool, which can be used to operate the opening and closing of the molding tool W and the ejection of the finished part, also not shown, and also contains various smart light indicators for the different phases of the RTM process, such as the process status of the RTM process, errors during the process, etc.

This small control station is only used for operation before and after the start of the RTM process. Once the process has started, all functions are controlled via the main control unit 1 until the RTM process is complete. After completion of the process, the finished part, which is impregnated with resin and cured, is removed with the aid of a pneumatic or hydraulic ejector system (not shown) that is built into the mold.

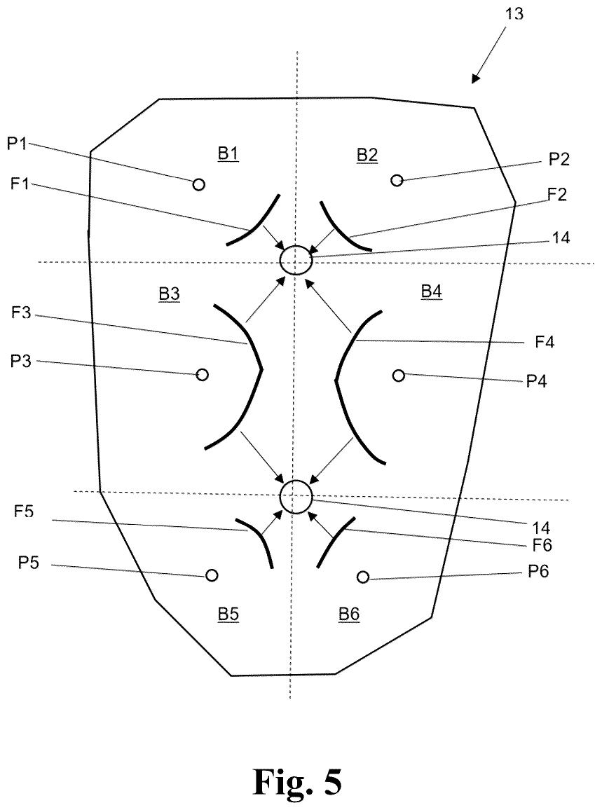

FIG. 5 shows a highly simplified representation of flow fronts F1 to F6 of injected resin mixture, which was injected into the mold via six injection points P1 to P6.

The outline of a mold cavity 13 is shown schematically, which is divided into six areas B1 to B6, see dashed lines. The division of areas B1 to B6 is based on the surface division of the preform and the component to be manufactured from it. Each area B1 to B6 has an injection point P1, P2 . . . P6 through which resin mixture was injected into the mold cavity 13.

Here, the flow fronts F1, F2, and F5, F6 are closer to a resin outlet 14 than the flow fronts F3, F4, as indicated by the shorter and longer arrows. At the same flow velocity, flow fronts F1, F2, F5, and F6 would therefore reach the resin outlets 14 first and exit from them. The disadvantage of this is that air bubbles from the resin mixture in areas B3 and B4 cannot escape, or can only escape insufficiently. Since all flow fronts F1 to F6 are detected by corresponding sensors in the mold, it is now possible to influence them in such a way that the flow fronts meet simultaneously at the resin outlets 14. This is achieved by reducing the injection pressure in the areas (here B1, B2, B5, B6) where the flow fronts (here F1, F2, F5, F6) are closer to the resin outlets 14, and/or by increasing the injection pressure in the areas (here B3, B4) in which the flow fronts (here F3, F4) are further away from the resin outlets 14.

Alternatively or additionally, the injected volume of the resin mixture at the injection points (here P1, P2, P5, P6) can also be reduced and/or the injected volume at the injection points (here P3, P3) can be increased.

It is also possible to provide a further resin outlet 14 between the two areas B3 and B4, from which resin mixture supplied via the flow fronts F3 and F4 can then escape.

In order to meet the demands of digitalization in industrial production, the sensors of the largely “IO-Link” (IO-Link is the first globally standardized IO technology (IEC 61131-9) for communicating with sensors and actuators)

This system enables bidirectional communication of values, switching states, device data, and status information “on demand.”

The invention has created a novel, efficient, and complex system for an RTM process with multiple injection technology (RTM) as well as an RTM process with which even very large components can be manufactured in high quality in a short time.

The present invention is not limited to embodiments described herein; reference should be had to the appended claims.

### LIST OF REFERENCE SIGNS

1 Main control unit
2 Upper mold half
3 Lower tool half
4.1, 4.2 . . . 4.n Injection unit(s)
5 Temperature sensor(s)
6 Pressure sensor(s)
7 Inclination sensor(s)
8 Distance sensor(s)
9 Sensors for flow detection
9.1 Sensors for monitoring curing
10 Preform
11 Core materials
12 Outer fiber layers (e.g., made of fabric)
13 Mold cavity
14 Resin outlet
15 Capacitive sensor/capacitive sensors
15.1 Transparent area
16 Resin closing unit
17 Refill station
18 Large storage container with resin (component 1)
19 Large storage container with hardener (component 2)
20 Large storage container with cleaning fluid
21 Additional container for return flow of the resin system (resin+hardener)
22 Monitor/PC
23 Electrical circuits and switchboards
24 Sensor display(s) and switch(es)
25 Small storage container on the injection unit for resin (component 1)
26 Small storage container on the injection unit for hardener (component 2)
27 Small storage container on the injection unit for cleaning fluid
28 Level sensor(s)
29 Pre-pump(s) or gear pump(s)
30 Dosing pump(s)
31 Flow sensor(s)
32 Mixing head
33 Temperature sensor and/or pressure sensor and/or density/ultrasonic/optical sensor
34 Bypass system
B1, B2 . . . B6 Areas
C Cable
F1, F2 . . . F6 Flow areas
H Heatable hoses
P Pipes
P1, P2 . . . Pn Injection points
W Molding tool
Z1, Z2, . . . Zn Feed lines from injection units 4.1, 4.2 . . . 4.n to injection points P1, P2, . . . Pn

What is claimed is:

1. System for carrying out an RTM (resin transfer molding) process with multiple injection technology with a molding tool (W) which has an upper mold half (2) and a lower mold half (3) with a mold cavity (13) formed between them for inserting a preform (10), characterized in that the system comprises a main control unit (1) and a plurality of injection units (4.1, 4.2 . . . 4.n) for feeding resin mixture into the mold cavity (13) and a plurality of injection points (P1, P2 . . . Pn) lead from the injection units (4.1, 4.2 . . . 4.n) into the molding tool (W) and its mold cavity (13), wherein sensors for monitoring process parameters are integrated into the molding tool (W) and/or the injection units (4.1, 4.2 . . . 4.n) for monitoring process parameters, and the sensors communicate with the main control unit (1), and in that the tool (W) has a plurality of resin outlets (14).

2. System according to claim 1, characterized in that sensors for detecting the flow behavior of the injected resin mixture are integrated into the molding tool, in particular flow detection sensors in the form of pressure, optical, and/or ultrasonic sensors, and in that at least one capacitive sensor is arranged on a vent hose at at least one resin outlet of the molding tool.

3. System according to claim 1 or 2, characterized in that the main control unit (1), as the brain of the plant (master), is coupled to the injection units (4.1, 4.2 . . . 4.n) for the transmission of commands and in that, in particular, the sensors integrated into the molding tool (W) transmit data to the main control unit (1) in real time.

4. System according to one of claims 1 to 3, characterized in that critical data can be displayed with the main control unit (1) via the data transmitted continuously in real time and/or the status of an RTM process can be displayed, wherein in particular data from the molding tool can be analyzed with the main control unit (1) can be used to analyze data from the molding tool in order to evaluate the performance of each individual injection unit and the resin distribution within the mold, and the actual process parameters can be compared with predefined targets or setpoints using the main control unit, in particular to determine whether adjustments are necessary.

5. System according to one of claims 1 to 4, characterized in that parameters changed with the main control unit (1) can be transmitted to each individual injection unit (4.1, 4.2 . . . 4.n) so that these settings can be implemented independently of each other in each injection unit.

6. System according to one of claims 1 to 5, characterized in that the position of flow fronts can be determined from the data transmitted to the main control unit (1) by the sensors, wherein it is preferably possible to recognize at which points resin flow fronts will meet by the main control unit (1) recognizing resin flow fronts.

7. System according to one of claims 1 to 6, characterized in that an area where the resin flow fronts meet can be directed to a resin outlet (14) and/or a vent opening of the molding tool (W) via the main control unit (1).

8. System according to one of claims 1 to 7, characterized in that the speed of flow fronts can be varied by changing the injection pressure and/or changing the flow rates of the individual injection units in order to direct them to a resin outlet (14) and/or a vent opening of the molding tool (W).

9. System according to one of claims 1 to 8, characterized in that it has at least one sensor on the outlet side of the molding tool (W) or its resin outlet (14) or in an area downstream of the resin outlet (14) for detecting air bubbles in the resin mixture.

10. System according to claim 9, characterized in that the at least one sensor for detecting air bubbles is designed in the form of a capacitive sensor (15) and/or an optical sensor.

11. System according to claim 10, characterized in that, in the area of the arrangement of the sensor for detecting air bubbles, an area through which the resin mixture flows is designed as a transparent area (15.1) and in that the capacitive sensor 15 and/or the optical sensor is arranged on the outside of the transparent area.

12. System according to one of claims 1 to 11, characterized in that the sensor(s) for detecting air bubbles are connected to the main control unit (1) and transmit information about the amount of air bubbles present in the resin mixture to the main control unit (1), and in that a signal can be transmitted to the resin closing unit via the main control unit in order to automatically close and open the resin outlets.

13. System according to one of claims 1 to 12, characterized in that at least one pressure sensor (5) is arranged in the molding tool (W), with which the internal pressure in the molding tool (W) during the injection process, and in that the injection pressure is determined by means of at least one further pressure sensor in front of the molding tool (W), and the internal pressure and the injection pressure can be transmitted to the main control unit (1) and can be compared and controlled by a control logic with predefined maximum pressure values.

14. Resin transfer molding process (RTM process), carried out with a system according to claim 1, characterized in that a multi-injection RTM process is carried out in the molding tool (W) with the multiple injection units (4.1, 4.2 . . . 4.n) via a plurality of injection points (P1, P2 . . . Pn), which is controlled via the main control unit (1), wherein coordination between the main control unit (1), the individual injection units (4.1, 4.2 . . . 4.n) and the sensors in and on the molding tool (W) and/or the injection units (4.1, 4.2 . . . 4.n) takes place throughout the entire multi-injection RTM process, including a curing process.

15. Process according to claim 14, characterized in that the main control unit (1) serves as the brain of the plant (master) and transmits commands to the individual injection units, and in that the injection units act as executors of the commands (slaves), and in that, advantageously, the main control unit transmits the required change in the process parameters to each individual injection unit (4.1, 4.2 . . . 4.n), so that each injection unit (4.1, 4.2 . . . 4.n) receives and implements these changes independently of each other.

16. Process according to claim 14 or 15, characterized in that sensors embedded in the system continuously transmit data to the main control unit (1) in real time and the status and dynamics of the RTM process can be determined/displayed by means of the main control unit.

17. Process according to one of claims 14 to 16, characterized in that the main control unit analyzes the data determined by the sensors in the molding tool and transmitted to the main control unit, evaluates the performance of each individual injection unit and the resin distribution within the mold, compares this data of the actual process parameters with predefined target values, and, in the event of deviations from the target values, the necessary changes to the process parameters are defined by the main control unit.

18. Process according to one of claims 14 to 17, characterized in that the position of resin flow fronts is detected by real-time communication between the sensors used in the molding tool (1) and the main control unit, and in that the main control unit can be used to determine at which points in the molding tool (1) the resin flow fronts will meet.

19. Process according to one of claims 14 to 18, characterized in that the area where the flow fronts meet is directed to a venting point, for which the speed of the flow fronts can be changed by changing the injection pressures of the injection units (4.1, 4.2 . . . 4.n) and/or the flow rates.

20. Process according to one of claims 14 to 19, characterized in that during the injection process, air bubbles and the amount of air bubbles in the resin mixture emerging from the resin outlets of the molding tool are detected by means of capacitive sensors and/or optical sensors.

21. Process according to one of claims 14 to 20, characterized in that the capacitive and/or optical sensors transmit information about the amount of air bubbles present in the resin system to the main control unit and in that the process parameters such as injection pressure and/or flow rate of one or more injection units are changed simultaneously in order to prevent air bubbles in the molding tool, and in that, in particular, after the main control unit has changed the process parameters of the injection units, the changes are analyzed on the basis of the data from the capacitive sensors and/or optical sensors and a signal is sent to the resin closing unit to automatically close the resin outlets when resin mixture exits without air bubbles, or to open them when air bubbles are detected.

22. Process according to one of claims 14 to 21, characterized in that during the injection process, the internal pressure in the molding tool and the injection pressure of the injection units to the molding tool are continuously monitored, and in that areas in the molding tool with excessive pressure (above a defined limit value) are automatically detected, and in that an outlet in this area or areas is opened by communication with the resin closing unit or the control parameters of the injection units until the pressure is within the limit range again.
